(19) United States
(12) Patent Application Publication
(10) Pub. No.: US 2014/0003255 A1
(43) Pub. Date: Jan. 2, 2014

(54) IDENTIFYING THE LOGICAL LOCATION OF A NETWORK DEVICE

(71) Applicant: PAUL BEYER, Holmdel, NJ (US)

(72) Inventor: PAUL BEYER, Holmdel, NJ (US)

(73) Assignee: VONAGE NETWORK LLC, Holmdel, NJ (US)

(21) Appl. No.: 13/537,507

(22) Filed: Jun. 29, 2012

(51) Int. Cl. H04L 12/28; H04L 12/26

(52) U.S. Cl. 370/252

(57) ABSTRACT

A method and apparatus for identifying logical locations of network devices on a Local Area Network (LAN) is provided herein. The method may include receiving an input including a network identifier of a network terminal adaptor on a LAN, determining, using the received network identifier, network devices connected upstream and downstream of the network terminal adapter on the LAN, and collecting device telemetry data associated with each determined network device and the network terminal adaptor, and generating, using the device telemetry data, a data structure including (a) a representation of a logical location of the network terminal adaptor and of each determined network device connected to the LAN, and (b) at least some of the device telemetry data.

### BACKGROUND OF THE INVENTION

1. Field of the invention

Embodiments of the present invention generally relate to computer networks and, more particularly, to a method and apparatus for identifying logical locations of network devices on a Local Area Network (LAN).

2. Description of the Related Art

Voice-over-Internet Protocol (VoIP) is a technological development in the field of telecommunications that is utilized to transmit voice conversations over a data network using Internet Protocol (IP) packets rather than the existing and traditional telecommunications system more commonly referred to as the Public Switched Telephone Network (PSTN) or Plain Old Telephone Service (POTS). Entities (e.g., businesses or individuals) implement VoIP by purchasing and installing the necessary equipment (e.g., one or more VoIP Terminal Adaptors (TA)) to access a VoIP service provider and activating this telecommunication service via a broadband Internet connection.

Typically, entities will not solely have telecommunications equipment connected to the broadband Internet connection. Various other data networking devices including but not limited to computers, peripherals and wireless networking devices will comprise a substantial Local Area Network (LAN) that is connected to a Wide Area Network (WAN) with a multitude of services available via the broadband Internet connection. Such VoIP systems may interface with other devices connected to the home network. However, these other devices connected to a user's home network may cause problems with the VoIP systems/service if not operating properly, configured incorrectly, outdated, and the like.

Typically, VoIP service providers have customer care service centers to interact and provide customer service to VoIP telephony users. One problem typically encountered by customers who interact with a support communications center is the need to provide detailed sets of information regarding the state and configuration of the customer's internal home network (e.g., how network devices are connected in the customer's internal home network) each time the customer starts a communications session or interacts with an operator. This information is typically required in order to troubleshoot problems that may be encountered by a VoIP telephony user.

It would be beneficial if methods and apparatus were developed which improved the customer experience by reducing the amount of redundant or inaccurate customer input. In addition to improving the customer experience, the reduced time to ascertain the state and configuration of a user's home network would translate directly into reduced costs and improve capital utilization. Therefore, there is a need in the art for an improved method and apparatus for determining the network topology of a customer's LAN.

### SUMMARY OF THE INVENTION

A method and apparatus for identifying logical locations of network devices on a LAN is provided herein. In some embodiments, the method includes receiving an input including a network identifier of a network terminal adaptor on a LAN, determining, using the received network identifier, network devices connected upstream and downstream of the network terminal adapter on the LAN, and collecting device telemetry data associated with each determined network device and the network terminal adaptor, and generating, using the device telemetry data, a data structure including (a) a representation of a logical location of the network terminal adaptor and of each determined network device connected to the LAN, and (b) at least some of the device telemetry data.

In some embodiments, an apparatus for identifying logical locations of network devices on a LAN is provided which includes a) at least one processor, b) at least one input device, and c) at least one storage device storing processor-executable instructions which, when executed by the at least one processor, perform a method including: receiving an input including a network identifier of a network terminal adaptor on a LAN; determining, using the received network identifier, network devices connected upstream and downstream of the network terminal adapter on the LAN and collecting device telemetry data associated with each determined network device; and generating, using the device telemetry data, a data structure including (a) a representation of a logical location of each of the network terminal adaptor and of each determined network device connected to the network terminal adaptor on the LAN, and (b) at least some of the device telemetry data.

In some embodiments, a computer readable medium storing a software program that, when executed by a computer, causes the computer to perform a method for identifying logical locations of network devices on a LAN including receiving an input including a network identifier of a network terminal adaptor on a LAN, determining, using the received network identifier, network devices connected upstream and network devices connected downstream of the network terminal adapter on the LAN, and collecting device telemetry data associated with each determined network device, and generating, using the device telemetry data, a data structure including (a) a representation of a logical location of each of the network terminal adaptor and of each determined network device connected to the network terminal adaptor on the LAN, and (b) at least some of the device telemetry data.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting an exemplary embodiment of a communication system in accordance with one or more aspects of the invention;

FIG. 2 is a block diagram depicting an exemplary embodiment of a Local Area Network (LAN) topology in accordance with one or more aspects of the invention;

FIG. 3 is a flow diagram depicting a method for identifying logical locations of network devices on a customer's Local Area Network (LAN) in accordance with one or more aspects of the invention;

FIG. 4 is a flow diagram depicting an upstream network device recursive method for recursively determining upstream network devices in accordance with one or more aspects of the invention;

FIG. 5 is a flow diagram depicting an downstream network device recursive method for recursively determining downstream network devices in accordance with one or more aspects of the invention;

FIG. 6 is a flow diagram depicting a method for generating a graphical network map in accordance with one or more aspects of the invention; and

FIGS. 7A and 7B are block diagrams depicting an exemplary graphical network map of a customer's LAN topology in accordance with one or more aspects of the invention.

While the methods and apparatus are described herein by way of example for several embodiments and illustrative drawings, those skilled in the art will recognize that method and apparatus for identifying logical locations of network devices on a LAN is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of method and apparatus for identifying logical locations of network devices on a customer's Local Area Network. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to.

### DETAILED DESCRIPTION

Embodiments of the present invention include a method and apparatus for identifying logical locations of network devices on a customer's LAN. Using previously collected device telemetry environmental data (DTC data) from VoIP terminal adaptors on a customer's LAN, a logical representation of a customer's home network topology can be generated. DTC data is essentially a snapshot of a TA's WAN/LAN IP Addresses, LAN Dynamic Host Configuration Protocol (DHCP) Client Data, and WAN gateway data (i.e., a thorough depiction of network devices connected upstream and downstream of the TA on the LAN). Through a recursive set of processes, a representation of the logical location of network devices on the customer's network can be generated without requiring private access to the customer's LAN.

Various embodiments of an apparatus and method for identifying logical locations of network devices on a customer's LAN are provided below. In the following detailed description, numerous specific details are set forth to provide a thorough understanding of the claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

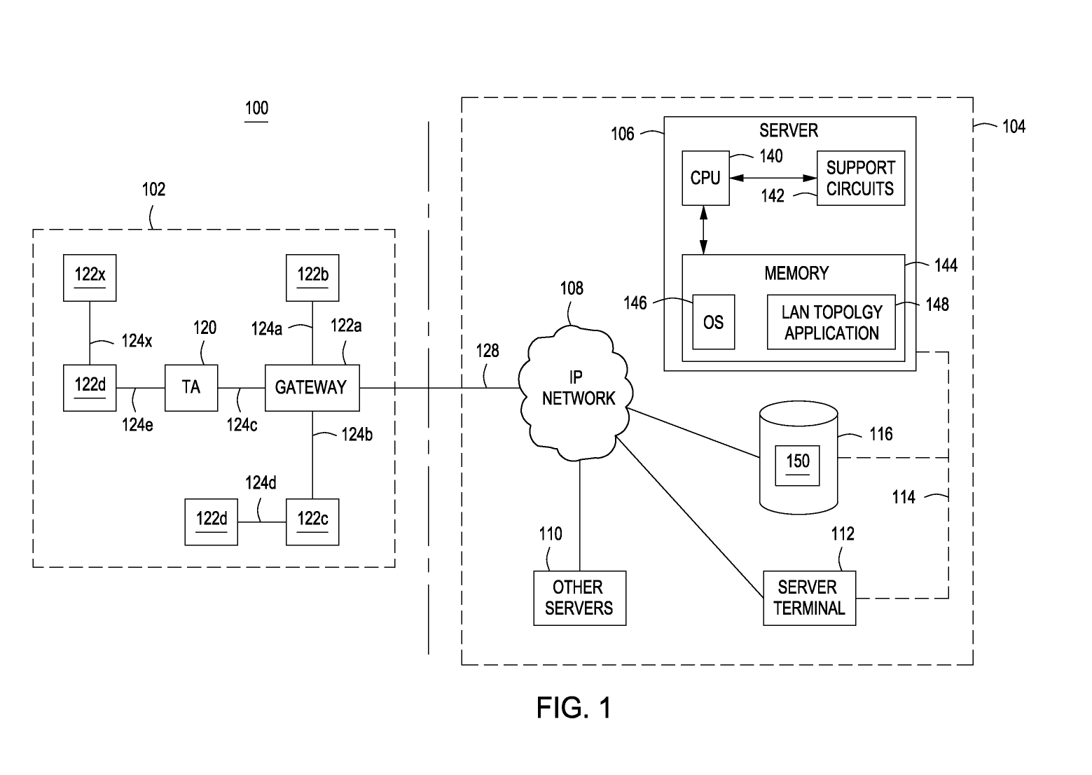

FIG. 1 is a block diagram depicting an exemplary embodiment of a communication system 100 in accordance with one or more aspects of the invention. The communication system 100 includes a customer's LAN 102 and a voice-over-internet-protocol (VOIP) network 104. The network 104 includes a server 106 and a plurality of other servers 110 coupled to an internet protocol (IP) network 108. In some embodiments, the servers 110 may be various well known servers configured to facilitate VOIP services, such as provisioning servers, proxy servers, media relay servers, and the like. The server 106 may be communicatively coupled, via IP network 108 or other internal network/links 114, to a database 116 that stores DTC data of various network devices in one or more device telemetry tables 150 (“DTC tables 150”). The server 106 is configured to generate a representation of a network topology of a customer's LAN 102 using the DTC data stored in the DTC table(s), as described below. The server 106 may be implemented using a plurality of computer systems and like-type general and/or specific purpose devices and systems.

The server 106 is represented in the form of a general purpose computer such as those generally known in the art that, when executing particular software becomes a specific purpose computer for performing various embodiments of the present invention. The server 106 may include one or more central processing units (CPU) 140 coupled to each of support circuits 142, and memory 144. The CPU 140 may comprise one or more commercially available microprocessors or microcontrollers that facilitate data processing and storage. The various support circuits 142 are utilized to facilitate the operation of the CPU 140 and may include such circuits as clock circuits, power supplies, cache, input/output (I/O) circuits and devices, modulation/demodulation devices, human interface devices, and the like. In some embodiments, the support circuits 142 may include a display device (not shown) and an input device (not shown) that provides a Web front end to a service representative to accept input and send/receive input that may be used in a LAN topology generation application 148 described below.

The memory 144 may comprise random access memory, read only memory, removable storage, optical disk storage, disk drive storage, flash memory, and combinations thereof. The memory 144 may store software that is executed to perform methods of according to embodiments of the invention. For example, the software can implement at least a portion of the methods 300, 400, 500 and 600 performed by server 106 or other servers 100 in the VoIP network 104. The software, when executed by the CPU 140, transforms the general purpose computer into a specific purpose computer that controls methods described herein. The software stored in memory 144 includes an operating system 146 and the LAN topology generation application 148. Such operating system 146 may include Linux, UNIX, Apple OS, Windows, and the like. In operation, the CPU 140 executes the operating system 146 to control the general utilization and functionality of server 106. The LAN topology generation application 148 operates to identify the logical location of network devices on a customer's LAN 102 in some embodiments consistent with the present invention. The LAN topology generation application 148 does so by generating a data structure including a representation of the logical location of network devices connected to LAN 102. In some embodiments, the LAN topology generation application 148 is a standalone application that informs other applications of the network topology of a customer's LAN 102. One of ordinary skill in the art would recognize that such a LAN topology generation application 148 may be implemented as a component of the operating system 146, as a device driver, as part of a separate application, as an application program interface (API) or in any other type of software as commonly known in the art. In some embodiments, the LAN topology generation application may be implemented in any of software, firmware, hardware, or a combination thereof.

In some embodiments consistent with the present invention, a service terminal 112, such as one used by a customer service representative of a VoIP service provider, is coupled to the VoIP network 104. The service terminal 112 may be coupled to server 106 via IP network 108 or via other internal network/links 114 separate from IP network 108. In some embodiments, the service terminal 112 may include a display device (not shown) and an input device (not shown) that provides a Web front end to a service representative to accept input and send/receive input from server 106.

LAN 102 may include a VoIP terminal adaptor (TA) 120 and various network devices 122a-x coupled directly or indirectly to the IP network 108 via links 128. It should be understood that LAN 102 may include more or less network devices than depicted in FIG. 1. The TA 120 couples to LAN 102 to provide internet telephony service. The TA 120 provides an interface for a phone (not shown) so that a user may connect the phone to TA 120 to enable voice service. The TA 120 transmits and receives telephony signals to a remote server on VoIP network 104 via a gateway network device (for example, network device 122a). In some embodiments the TA 120 provides a subscriber line interface circuit (SLIC) for interfacing with standard twisted pair phone cable. In some embodiments, the TA 120 communicates wirelessly with IP phones designed to be used with a VoIP system. Examples of such TAs 120 include the VDV21-VD router and VDV21-CVR wireless IP phone system, available from Vonage Holdings Corporation of Holmdel, N.J. The TA 120 may include a LAN port and a wide area network (WAN) port for configuring the network topology. In some embodiments, more than one TA 120 may be included in LAN 102.

The TA 120 typically collects DTC data from each of the network devices 122a-x connected on LAN 102. A DTC report is generated by TA 120 and sent to at least one of server 106 or other servers 110. The DTC reports sent by TA 120 may be generated and sent on a daily basis, upon startup of the TA 120, by manual request, or by any other configured schedule. The DTC data included in the DTC report is stored in DTC tables 150 in a database (e.g., database 116). The DTC data collected by TA 120 from each network device 122a-x, and/or from the TA 120 itself, may include, but is not limited to, device type, device vendor, LAN IP address, WAN IP address, MAC address, software version, uptime, VoIP service provider account number, one or more VoIP phone line numbers, registration status, recent telemetry events, and the like. In some embodiments consistent with the present invention, in the DTC tables 150, each entry for a specific network device stores the MAC and IP Addresses of each device that is connected immediately downstream to the specific network device (i.e., each DHCP client of that device). Thus, the “children” or downstream network devices the specific network device is associated with may be included in DTC tables 150. In addition, in some embodiments consistent with the present invention, each entry for a specific network device stores the specific network device's “wan_router_mac_address”. In other words, the MAC address of the upstream router (“parent”) it is connected to. Furthermore, in some embodiments consistent with the present invention, “siblings” of the specific network device can be found by searching for other network devices in the DTC table 150 with that same “wan_router_mac_address.”

As depicted in FIG. 1, the customer's LAN 102 may include network devices 122a-x and TA 120 coupled to each other via various links 124a-x. The links 124a-x may be direct or indirect hardwire links, wireless connections or a combination thereof.

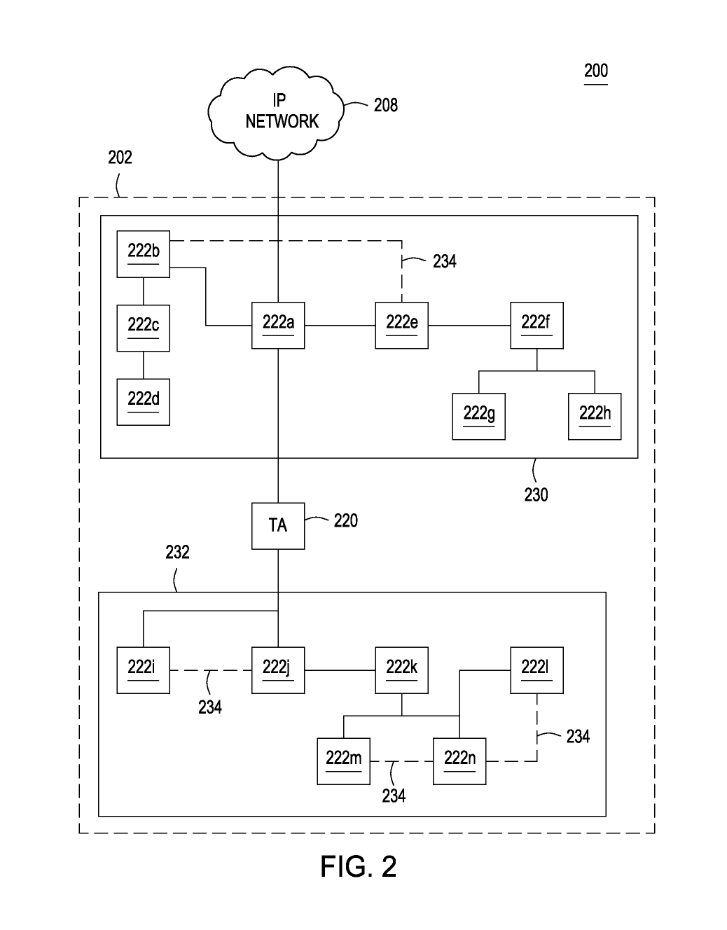

FIG. 2 is a graphical depiction of an exemplary network topology of a customer's LAN 202 that may be generated in accordance with at least some embodiments of the present invention. The customer's LAN 202 is coupled to an IP network 208 via a network device 222a (e.g., a gateway or router). A TA 220 is shown coupled to LAN 202. A number of network devices 222a-h connected upstream of the TA 220 on the LAN 202 are shown in block 230. A number of network devices 222i-n connected downstream of the TA 220 on the LAN 202 are shown in block 232.

In embodiments consistent with the present invention, a first network device that is connected upstream of a second network device (or a TA 220) is one that is coupled to the LAN 202 between the second network device (or the TA 220) and IP network 208, such that any communication between the second network device (or the TA 220) and IP network 208 passes through the first network device. For example, in FIG. 2, net device 222a is upstream of all network devices 222b-n and TA 220, network device 222b is upstream of network devices 222c and 222d. In addition, in embodiments consistent with the present invention, network devices connected that are connected to upstream network devices with respect to TA 220 are also considered upstream of TA 220. For example, network devices 222b-d and 222e-h are considered upstream of TA 220.

In embodiments consistent with the present invention, a first network device that is connected downstream of a second network device (or a TA 220) is one where the second network device (or the TA 220) is coupled to the LAN 202 between the first network device and IP network 208, such that any communication between the first network device and IP network 208 passes through the second network device (or the TA 220).

In embodiments consistent with the present invention, a first network device that is a sibling of a second network device is one where the first network device and the second network device are both communicatively coupled to a third common upstream network device, and therefore the first and second network devices logically exist at the same hierarchical network level. For example, in FIG. 2, network devices 222b and 222e are siblings, network devices 222i and 222j are siblings, and network devices 222l, 222m and 222n are siblings. In FIG. 2, sibling connections are shown by links 234.

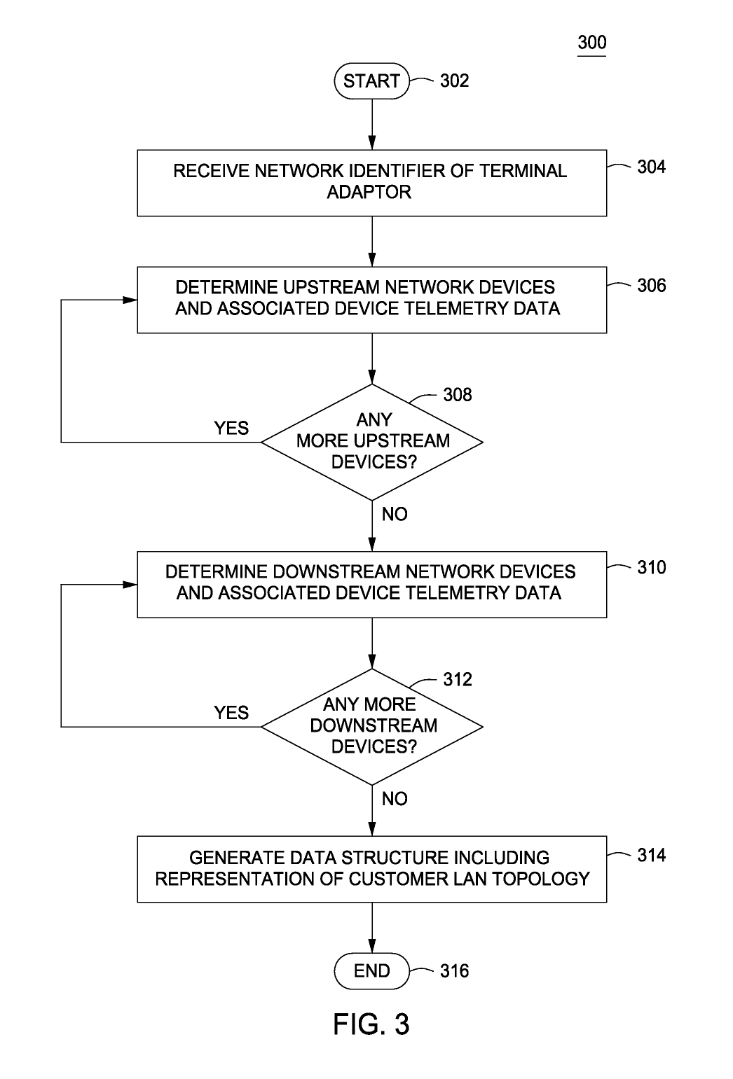

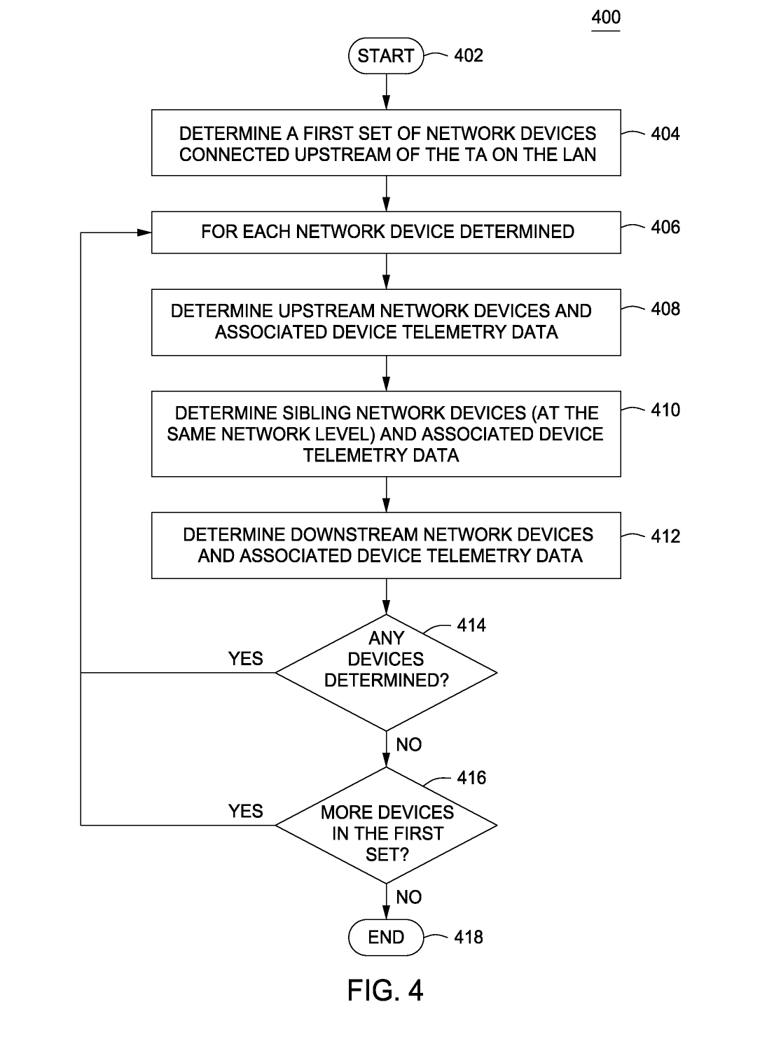

In embodiments consistent with the present invention, all network devices connected upstream of TA 220 are recursively determined. For example, using a network identifier of TA 220, a DTC table in database 116 may be queried using the network identifier to identify upstream devices. For each upstream device found, an upstream recursive process is performed (discussed below in more detail with respect to FIGS. 3 and 4) which determines all upstream, sibling (i.e., at the same network level), and downstream devices of each upstream network device found. For example, network device 222a is determined to be connected upstream of TA 220 in LAN 202. The device telemetry data associated with network device 222a (which may include a network identifier of network device 222a) is used to determine all upstream, sibling (i.e., at the same network level), and downstream devices of network device 222a. As shown in FIG. 2, network device 222a does not have any upstream or sibling devices. However, network devices 222b and 222e would be determined to be downstream devices of network device 222a (and upstream devices of TA 220). The upstream recursive process is then performed on each of network device 222b and 222e. The upstream recursive process is further performed on any network devices found in block 230. That is, the upstream recursive process resolves all upstream, sibling, and downstream network devices for any network device determined to be upstream of TA 220 on LAN 202.

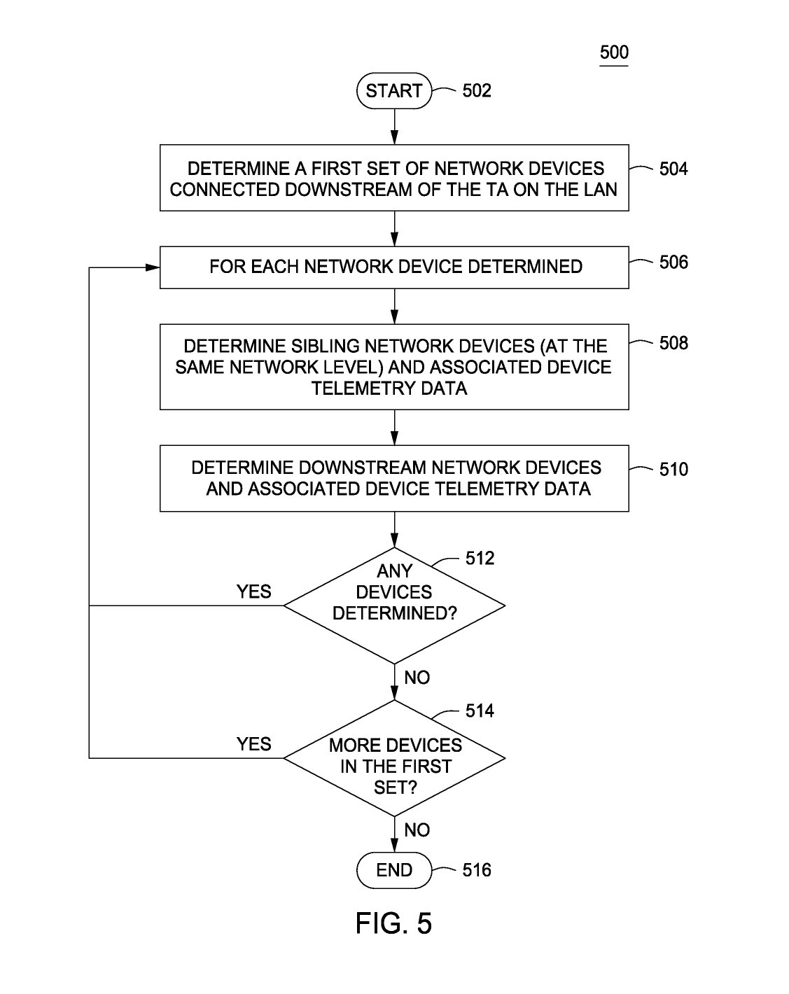

Similarly, in embodiments consistent with the present invention, all network devices connected downstream of TA 220 are recursively determined. However, unlike the upstream recursive process, a downstream recursive process (described in more detail below with respect to FIG. 5) resolves sibling and downstream network devices, but not upstream network devices, for any network device determined to be downstream of TA 220 on LAN 202 (i.e., located in block 232 of FIG. 2).

FIG. 3 depicts a flow diagram of a method 300 of operation for identifying logical locations of network devices on a customer's LAN in accordance with at least one embodiment of the present invention. The method 300 is performed by server 106 in some embodiments consistent with the present invention. The method 300 begins at step 302 and proceeds to step 304, where a network identifier of a TA is received. The network identifier may include, but is not limited to, a MAC address, an LAN IP address, a WAN IP address, and the like. In some embodiments, the network identifier of the TA is received by server 106 from service terminal 112. For example, a customer service representative at a VoIP service provider may be assisting a VoIP customer regarding an issue with their VoIP service. The customer service representative may input a TA MAC address (of a TA being used by the customer on the customer's LAN) via a Web front end running on service terminal 112. The server 106 may receive said MAC address (e.g., a network identifier of the TA adaptor) from service terminal 112 via IP network 108 or connections 114.

The method 300 then proceeds to 306 where all network devices connected upstream of the TA on the customer's LAN are determined along with device telemetry data associated with each determined upstream device and the TA. At step 308, the method 300 determines if there are any more upstream network devices and continues to perform steps 306 and 308 for each device found and until all upstream devices have been resolved. The upstream recursive procedure for determining all upstream devices is described in more detail with respect to FIG. 4 below.

The method 300 then proceeds to 310 where all network devices connected downstream of the TA on a customer's LAN are determined along with device telemetry data associated with each determined downstream device and the TA. At step 312, the method 300 determines if there are any more downstream network devices and continues to perform steps 310 and 312 for each device found and until all downstream devices have been resolved. The downstream recursive procedure for determining all downstream devices is described in more detail with respect to FIG. 5 below.

After all upstream and downstream devices with respect to the TA have been resolved, the method 300 generates a data structure including representation of customer LAN topology at step 314. The representation of the customer LAN topology includes a representation of the network TA, of each determined network device connected to the network TA on the LAN, and of at least some of the associated device telemetry data. In some embodiments consistent with the present invention, the representation may be one of a Markup Language (XML) representation or a JavaScript Object Notation (JSON) representation. Other data representations may also be used. The method 300 then ends at 316.

FIG. 4 depicts a flow diagram of a method 400 of operation for further determining network devices connected upstream of a TA on a customer's LAN in accordance with one or more embodiments of the present invention. Method 400 is an upstream recursive process that provides further details with respect to step 306 in FIG. 3. The method 400 begins at step 402 and proceeds to step 404 where a first set of network devices connected upstream of the network TA on the LAN is determined. In embodiments consistent with the present invention, associated device telemetry data for each determined network device in the first set is also determined/collected at this step. The method 400 then performs steps 406 through 416 recursively for each determined network device in the first set, and for each subsequent network device found. Specifically, for each network device determined (at step 406), the method 400 determines upstream network devices and associated device telemetry data at step 408. For example, the method 400 may use a MAC address of a network device included in the associated device telemetry data to determine if that MAC address appears the in DTC table 150 for other network devices (e.g., in a “lan_dhcp_client_table_data” field). Thus, in some embodiments of the present invention, if other network devices include the MAC in their “lan_dhcp_client_table_data” field, they are considered upstream devices.

Next, for each network device determined (at step 406), the method 400 determines sibling network devices (at the same network level of the network device being analyzed) and associated device telemetry data at step 410. For example, the device telemetry data for each network device in the DTC table 150 includes a “wan_router_mac_address” (i.e., the MAC address of the upstream router it's connected to). Thus, in some embodiments of the present invention, the method 400 can find siblings of a network device by searching for other network devices in the DTC table 150 with that same “wan_router_mac_address”.

At step 412, downstream network devices and associated device telemetry data are determined/collected. For example, the device telemetry data for each network device in the DTC table 150 includes a “lan_dhcp_client_table_data” field (i.e., the MAC address of “children” network devices). Thus, in some embodiments of the present invention, the method 400 can find children of a network device (i.e., downstream network devices) using the “lan_dhcp_client_table_data” field.

At step 414, if network devices were determined in any of steps 408, 410 and 412, the method 400 returns to step 406. At step 414, if no network devices were determined in steps 408, 410 and 412, the method 400 proceeds to step 416. At step 416, if there are more devices in the first set of network devices determined in step 404 that have not been recursively processed, the method 400 returns to step 406. At step 416, if all devices in the first set of network devices determined in step 404 were recursively processed, the method 400 ends at step 418.

Although not shown in FIG. 4, in some embodiments consistent with the present invention, if an entry for a network device determined in steps 408, 410 and 412 is not found in DTC table 150, the method 400 may search publicly available records (e.g., IEEE records) for the vendor or manufacturer of the network device using the network devices MAC address.

FIG. 5 depicts a flow diagram of a method 500 of operation for determining all network devices connected downstream of a TA on a customer's LAN in accordance with one or more embodiments of the present invention. Method 500 is a downstream recursive process that provides further details with respect to step 310 in FIG. 3. The method 500 begins at 502 and proceeds to 504 where a first set of network devices connected downstream of the network terminal adapter on the LAN is determined. In embodiments consistent with the present invention, associated device telemetry data for each determined network device in the first set is also determined/collected at this step. The method 500 then performs steps 506 through 514 recursively for each determined network device in the first set, and for each subsequent network device found. Specifically, for each network device determined (step 506), the 500 method determines sibling network devices (at the same network level of the network device being analyzed) and associated device telemetry data at step 508, and determines downstream network devices and associated device telemetry data at step 510. At step 512, if network devices were determined in any of steps 508 and 510, the method 500 returns to step 506. At step 512, if no network devices were determined in steps 508 and 510, the method 500 proceeds to step 514. At step 514, if there are more devices in the first set of network devices determined in step 504 that have not been recursively processed, the method 500 returns to step 506. At step 514, if all devices in the first set of network devices determined in step 504 were recursively processed, the method 500 ends at 516.

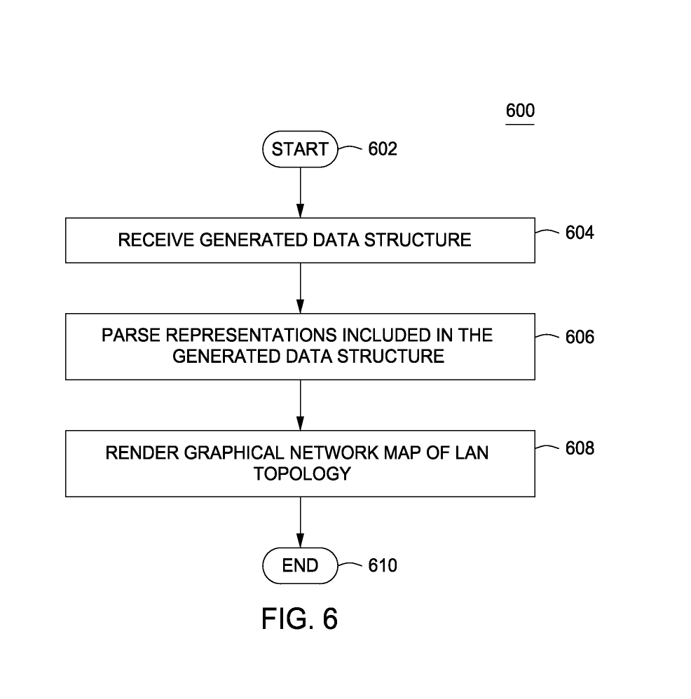

FIG. 6 depicts a flow diagram of a method 600 of operation for rendering, a graphical network map including the network TA and each determined network device connected to the LAN in accordance with one or more embodiments of the present invention. The method 600 begins at 602 and proceeds to 604 where a generated data structure is received. In some embodiments consistent with the present invention, the data structure includes XML or JSON data representations of a customer's network topology (i.e., the topology of the customer's LAN). The data structure is generated consistent with embodiments described above. At step 606, the representations included in the generated data structure are parsed. At step 608, the parsed representations are used to render a graphical network map of the customer's LAN topology. The method ends at 610.

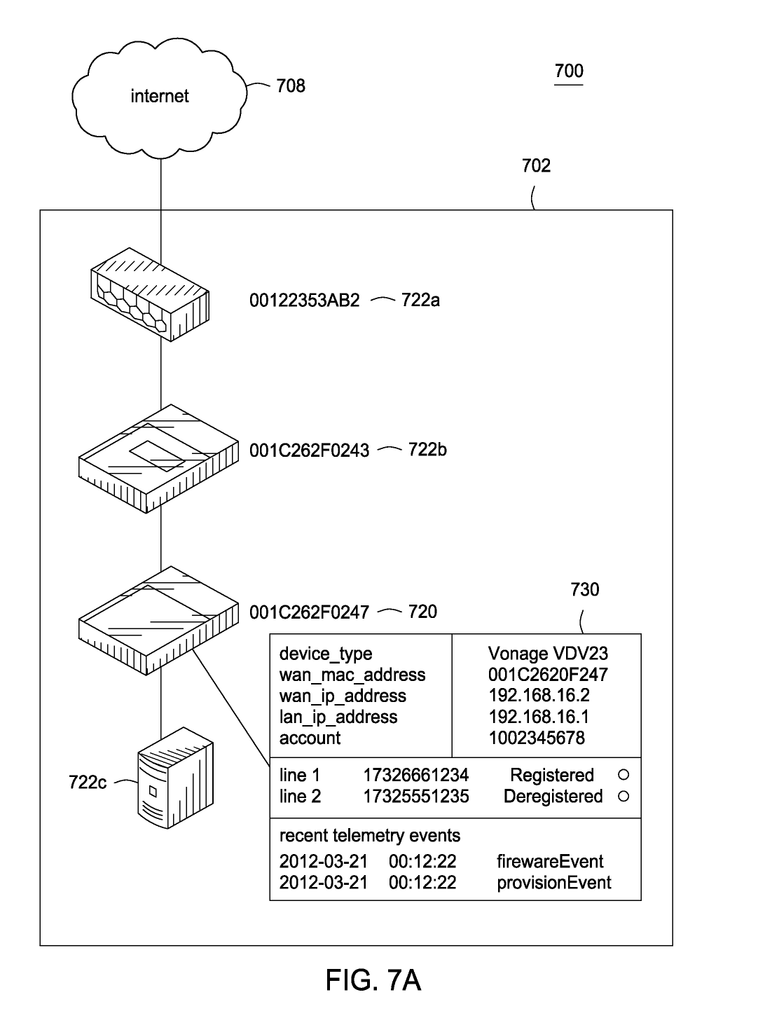

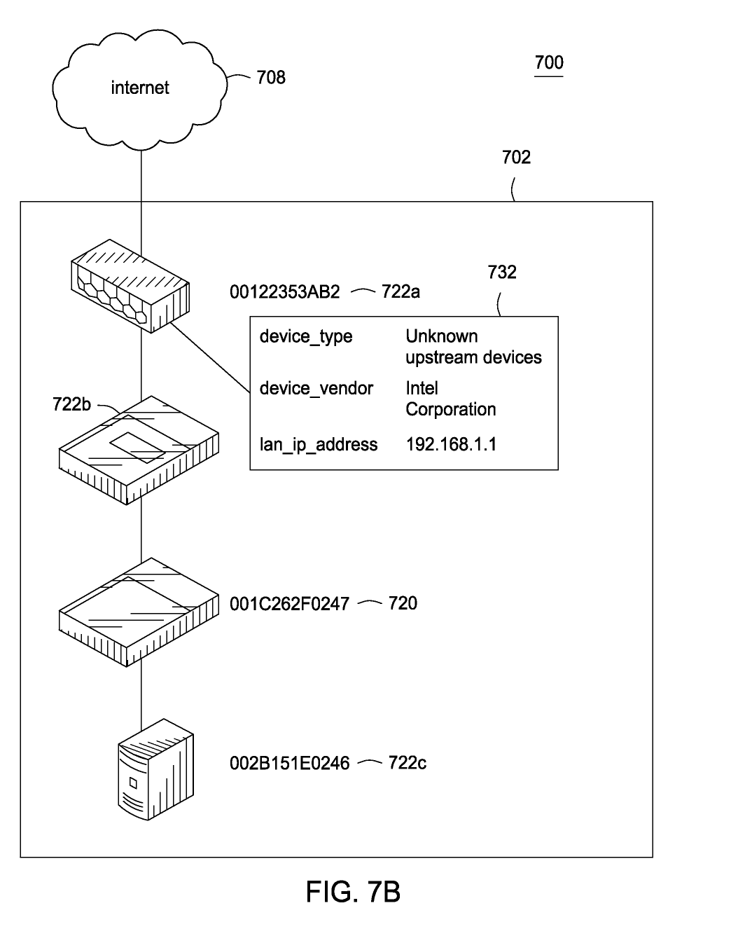

FIG. 7A depicts an exemplary graphical network map of a customer's LAN topology consistent with some embodiments described herein. In the network configuration shown in FIG. 7A, a customer LAN 702 includes a TA 720 coupled to the LAN 702. The graphical network map displays two upstream network devices 722a and 722b and one downstream device 722c are also coupled to the LAN. In addition, an IP network 708 is shown for reference coupled to LAN 702 via network device 722a. In some embodiments, the TA 720 and each of the network devices 722a-c are objects that can be selected or activated by a user to display more information. A “selection” by a user may include, but is not limited to, a mouse click, hovering over the object with a mouse point or other type input device, a touch screen selection using a finger or other type of input device, and the like. In FIG. 7A, at least some device telemetry data 730 of TA 720 is shown responsive to a selection of TA 720 on the graphical network map.

In FIG. 7B, the same elements of FIG. 7A are shown except that at least some device telemetry data 732 of network device 722a is shown responsive to a selection of network device 722a on the graphical network map.

Although not shown, the graphical user map may display differences in different network configurations that may have existed on different dates with respect to a customer's LAN. The prior configuration may be displayed as grayed or in a different color to emphasis the differences.

The foregoing description of embodiments of the invention comprises a number of elements, devices, circuits and/or assemblies that perform various functions as described. For example, support circuits 142 are an example of a means for receiving an input including a network identifier of a network terminal adaptor on a LAN, and one or more processors 140 and LAN topology generation application 148 are examples of means for determining, using the received network identifier, network devices connected upstream and downstream of the network terminal adapter on the LAN, and device telemetry data associated with each determined network device and the network terminal adaptor and a means for generating, using the device telemetry data, a data structure including a representation of the network terminal adaptor, of each determined network device connected to the network terminal adaptor on the LAN, and of at least some of the associated device telemetry data. These elements, devices, circuits, and/or assemblies are exemplary implementations of means for performing their respectively described functions.

While the foregoing is directed to embodiments of the present invention, other and further embodiments of the invention may be devised without departing from the basic scope thereof, and the scope thereof is determined by the claims that follow.

What is claimed is:

1. A method for identifying logical locations of network devices on a Local Area Network (LAN), at least a portion of the method being performed by a computer system comprising at least one processor, the method comprising:
receiving an input including a network identifier of a network terminal adaptor on the LAN;
determining, using the received network identifier, network devices connected upstream and downstream of the network terminal adapter on the LAN, and collecting device telemetry data associated with each determined network device and the network terminal adaptor; and
generating, using the device telemetry data, a data structure including (a) a representation of a logical location of the network terminal adaptor and of each determined network device connected to the LAN, and (b) at least some of the device telemetry data.

2. The method of claim 1, wherein determining network devices connected upstream of the network terminal adapter on the LAN includes:
determining, using the received network identifier, a first set of network devices connected upstream of the network terminal adapter on the LAN and collecting device telemetry data associated with each of the network devices in the first set; and
determining, using the device telemetry data associated with each determined network device in the first set, a further set of network devices connected upstream, at a same level, and downstream of each network device included in the first set, and device telemetry data associated with each network device in the further set.

3. The method of claim 2, wherein the act of determining the further set of network devices is recursively performed for each determined network device connected upstream, at the same level, and downstream of the network devices in the further set and until no new network devices are determined.

4. The method of claim 1, wherein determining network devices connected downstream of the network terminal adapter on the LAN includes:
determining, using the received network identifier, a first set of network devices connected downstream of the network terminal adapter on the LAN and collecting device telemetry data associated with each determined network device in the first set; and
determining, using the device telemetry data associated with each determined network device in the first set, a further set of network devices connected downstream and at a same level of each network device included in the first set, and device telemetry data associated with each network device in the further set.

5. The method of claim 4, wherein the act of determining the further set of network devices is recursively performed for each determined network device connected downstream and at the same level of the network devices in the further set and until no new network devices are determined.

6. The method of claim 1, wherein the network terminal adaptor is a Voice-over Internet Protocol (VoIP) terminal adaptor.

7. The method of claim 1, wherein the received network identifier is a Media Access Control (MAC) address.

8. The method of claim 1, wherein determining the network devices and the associated device telemetry data using the received network identifier includes using the received network identifier of the network terminal adaptor as a search query input of a device telemetry data table.

9. The method of claim 8, wherein the device telemetry data table includes information about the network devices connected to the LAN provided by the network terminal adaptor.

10. The method of claim 1, wherein the collected device telemetry data associated with each of the determined network devices connected upstream and downstream of the network terminal adaptor includes at least one of a Media Access Control (MAC) address, a Wide Area Network (WAN) internet protocol (IP) address, a LAN IP address, a device manufacturer, a model identifier, or a software version of identified network device.

11. The method of claim 1, wherein a format of the generated data structure is one of an Extensible Markup Language (XML) representation or JavaScript Object Notation (JSON) representation.

12. The method of claim 1, further comprising:
receiving the generated data structure;
parsing the representation and the at least some of the device telemetry data included in the generated data structure; and
rendering, using the parsed representation and device telemetry data, a graphical network map including the network terminal adaptor and each determined network device connected to the LAN.

13. The method of claim 12, wherein the network terminal adaptor and each determined network device connected to the LAN included on the rendered graphical network map are selectable, and wherein responsive to a user selection of the network terminal adaptor or at least one of the network device included on the graphical network map, at least some device telemetry data associated with the selected network terminal adaptor or the at least one network device is displayed.

14. The method of claim 1, wherein the received input further includes a configuration date of a specific LAN configuration and wherein the determined network devices were connected to the LAN on the configuration date received.

15. An apparatus for identifying logical locations of network devices on a Local Area Network (LAN), comprising:
a) at least one processor;
b) at least one input device; and
c) at least one storage device storing processor-executable instructions which, when executed by the at least one processor, perform a method including:
receiving an input including a network identifier of a network terminal adaptor on a LAN;
determining, using the received network identifier, network devices connected upstream and downstream of the network terminal adapter on the LAN, and collecting device telemetry data associated with each determined network device and the network terminal adaptor; and
generating, using the device telemetry data, a data structure including (a) a representation of a logical location of the network terminal adaptor and of each determined network device connected to the LAN, and (b) at least some of the device telemetry data.

16. The apparatus of claim 15, wherein determining network devices connected upstream of the network terminal adapter on the LAN includes:
determining, using the received network identifier, a first set of network devices connected upstream of the network terminal adapter on the LAN and collecting device telemetry data associated with each of the network devices in the first set; and
determining, using the device telemetry data associated with each determined network device in the first set, a further set of network devices connected upstream, at a same level, and downstream of each network device included in the first set, and device telemetry data associated with each network device in the further set.

17. The apparatus of claim 16, wherein the act of determining the further set of network devices is recursively performed for each determined network device connected upstream, at the same level, and downstream of the network devices in the further set and until no new network devices are determined.

18. The apparatus of claim 15, wherein determining network devices connected downstream of the network terminal adapter on the LAN includes:
determining, using the received network identifier, a first set of network devices connected downstream of the network terminal adapter on the LAN and collecting device telemetry data associated with each determined network device in the first set; and
determining, using the device telemetry data associated with each determined network device in the first set, a further set of network devices connected downstream and at a same level of each network device included in the first set, and collecting device telemetry data associated with each network device in the further set.

19. The apparatus of claim 18, wherein the act of determining the further set of network devices is recursively performed for each determined network device connected downstream and at the same level of the network devices in the further set and until no new network devices are determined.

20. A computer readable medium storing a software program that, when executed by a computer, causes the computer to perform a method for identifying logical locations of network devices on a Local Area Network (LAN) comprising:
receiving an input including a network identifier of a network terminal adaptor on a LAN;
determining, using the received network identifier, network devices connected upstream and downstream of the network terminal adapter on the LAN, and collecting device telemetry data associated with each determined network device and the network terminal adaptor; and
generating, using the device telemetry data, a data structure including (a) a representation of a logical location of the network terminal adaptor and of each determined network device connected to the LAN, and (b) at least some of the device telemetry data.
